(19) United States
(12) Patent Application Publication
(10) Pub. No.: US 2020/0264313 A1
(43) Pub. Date: Aug. 20, 2020

(54) LIDAR-BASED TURBULENCE INTENSITY ERROR REDUCTION

(71) Applicant: Alliance for Sustainable Energy, LLC, Golden, CO (US)

(72) Inventors: Jennifer Frances Newman, Arlington, MA (US); Andrew James Clifton, Stuttgart (DE)

(21) Appl. No.: 16/061,408

(22) PCT Filed: Dec. 14, 2016
(86) PCT No.: PCT/US16/66627

§ 371 Date: Jun. 12, 2018

Related U.S. Application Data
(60) Provisional application No. 62/267,025, filed on Dec. 14, 2015.

(51) Int. Cl. G01S 17/95; G01S 17/86; G01S 7/497; F03D 7/04

(52) U.S. Cl. CPC G01S 17/95; F03D 7/042; G01S 7/497; G01S 17/86

(57) ABSTRACT

Systems, devices, and methods for improving LIDAR-based turbulence intensity (TI) estimates are described. An example system may include a LIDAR instrument configured to determine, based on reflections of emitted light, a plurality of wind speed values. The system also includes a physics-based error correction module configured to determine, based on the wind speed values, at least one LIDAR-based meteorological characteristic value, and determine, based on the LIDAR-based meteorological characteristic value and at least one physical characteristic of the LIDAR instrument, at least one modified meteorological characteristic value. The system further includes a statistical error correction module configured to determine, based on the modified meteorological characteristic value and a meteorological characteristic error model generated using collocated LIDAR-based meteorological characteristic values and in situ instrument-based meteorological characteristic values, at least one corrected TI estimate, and output the corrected TI estimate.

This application claims the benefit of International Application No. PCT/US16/66627, filed Dec. 14, 2016, and U.S. Provisional Application No. 62/267,025, titled “LIDAR TURBULENCE MEASUREMENT ERROR REDUCTION” and filed Dec. 14, 2015, the entire content of each of which is incorporated herein by reference.

### CONTRACTUAL ORIGIN

The United States Government has rights in this invention under Contract No. DE-AC36-08G028308 between the United States Department of Energy and Alliance for Sustainable Energy, LLC, the Manager and Operator of the National Renewable Energy Laboratory.

### BACKGROUND

Meteorological measurements are used in numerous fields including energy, weather forecasting, aviation, and shipping and transportation. For example, the speed, direction, and shear of wind may be used in optimizing a wind farm to ensure maximum power production during changing meteorological conditions.

One method of obtaining meteorological measurements uses in situ instruments, such as cup anemometers, sonic anemometers, wind vanes, and others. In situ instruments may be attached to meteorological towers or “met towers” at various heights in order to measure the weather conditions that are experienced by turbines in a wind farm. While such instruments may provide accurate measurements, construction and maintenance of met towers to hold the instruments can be costly. A number of remote sensing technologies, such as light direction and ranging (“LIDAR”) or sound direction and ranging (“SODAR”), may provide another avenue for obtaining meteorological measurements.

### SUMMARY

In one example, a system includes a LIDAR instrument configured to emit light, receive reflections of the light, and determine, based on the reflections, a plurality of wind speed values. The system also includes a physics-based error correction module configured to determine, based on the plurality of wind speed values, at least one LIDAR-based meteorological characteristic value, and determine, based on the at least one LIDAR-based meteorological characteristic value and at least one physical characteristic of the LIDAR instrument, at least one modified meteorological characteristic value. The system further includes a statistical error correction module configured to determine, based on the at least one modified meteorological characteristic value and a meteorological characteristic error model generated using collocated LIDAR-based meteorological characteristic values and in situ instrument-based meteorological characteristic values, at least one corrected turbulence intensity estimate, and output the at least one corrected turbulence intensity estimate.

In another example, a method includes receiving, by a computing device and from a LIDAR instrument operatively coupled to the computing device, a plurality of wind speed values, determining, by the computing device and based on the plurality of wind speed values, at least one LIDAR-based meteorological characteristic value, and determining, by the computing device and based on the at least one LIDAR-based meteorological characteristic value and at least one physical characteristic of the LIDAR instrument, at least one modified meteorological characteristic value. The method further includes determining, by the computing device and based on the at least one modified meteorological characteristic value and a meteorological characteristic error model generated using collocated LIDAR-based meteorological characteristic values and in situ instrument-based meteorological characteristic values, at least one corrected turbulence intensity estimate, and outputting, by the computing device, instructions to cause modification of at least one operating parameter of a wind turbine based on the at least one corrected turbulence intensity estimate.

In another example, a non-transitory computer-readable medium is encoded with instructions that, when executed, cause at least one processor to receive, from a LIDAR instrument operatively coupled to the at least one processor, a plurality of wind speed values, determine, based on the plurality of wind speed values, at least one LIDAR-based meteorological characteristic value, and determine, based on the at least one LIDAR-based meteorological characteristic value and at least one physical characteristic of the LIDAR instrument, at least one modified meteorological characteristic value. The instructions further cause the at least one processor to determine, based on the at least one corrected meteorological characteristic value and a meteorological characteristic error model generated using collocated LIDAR-based meteorological characteristic values and in situ instrument-based meteorological characteristic values, at least one corrected turbulence intensity estimate, and output instructions to cause modification of at least one operating parameter of a wind turbine based on the at least one corrected turbulence intensity estimate.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating one example of an error compensating meteorology system, in accordance with one or more aspects of the present disclosure.

FIG. 2 is a flow diagram illustrating example operations for correcting TI estimates, in accordance with one or more aspects of the present disclosure.

FIGS. 3A-3D are scatter plots illustrating example LIDAR-based TI estimates compared to in situ instrument-based TI estimates, in accordance with one or more aspects of the present disclosure.

FIG. 4 is a block diagram illustrating a detailed example of various devices that may be configured to implement some embodiments in accordance with one or more aspects of the present disclosure.

### DETAILED DESCRIPTION

The present disclosure describes systems and devices configured to provide improved light detection and ranging (“LIDAR”) turbulence intensity (“TI”) measurements based on intelligent calibration using in situ instruments. TI is a measure of the small-scale fluctuations in wind and is a standard parameter used in wind resource assessment campaigns, turbine selection, and site suitability studies.

The meteorology systems and devices described herein may be used to more accurately predict wind farm meteorology and thereby improve wind turbine power generation. For instance, a meteorology system as described herein may obtain LIDAR data, and determine corrected TI estimates based on physical modeling and met tower (e.g., in situ instrument) data. The meteorology system may also output the corrected TI estimates and/or manage various aspects of a wind turbine or wind farm based on the corrected TI estimates. In some examples, the systems and devices described herein may utilize models and/or algorithms that are trained using collocated LIDAR and met tower (e.g., in situ instrument) data. Various meteorological parameters, such as wind speed, wind shear, and TI, and/or LIDAR instrument performance parameters, such as signal-to-noise ratio and internal instrument temperature may be used to determine the corrected TI estimates.

As wind turbine hub heights increase and wind energy expands to complex and offshore sites, new measurements of the wind resources may improve decisions regarding site suitability and wind turbine selection. Currently, most of these measurements are collected by cup anemometers and other in situ instruments on met towers. Met towers are usually fixed in location and the in situ instruments attached thereto typically only collect measurements up to and including the height corresponding to the wind turbine hub height. In addition, met towers are expensive to construct and maintain. For instance, a recent estimated cost for installing and maintaining an eighty meter, land-based met tower for a 2-year campaign is about 105,000 USD. The measurement of wind speeds across the entire wind turbine rotor disk can, however, be extremely important for power estimation, particularly as modern wind turbines increase in size. In response to the limitations of met towers for wind energy, remote sensing devices such as LIDAR instruments have been proposed as a potential alternative to cup anemometers and other in situ instruments.

Although LIDAR instruments may be capable of measuring mean wind speeds at several different measurement heights that may span an entire wind turbine rotor disk, and although LIDAR instruments may be easily moved from one location to another, they also may result in different TI estimates than an in situ instrument on a met tower, such as a cup or sonic anemometer. TI is a measure of small-scale fluctuations (i.e., turbulence) in the atmospheric flow and is an extremely important parameter in the wind energy industry. TI estimates may be used to classify potential wind farm sites and select suitable wind turbines, and can also impact power production—particularly near the rated wind speed of the wind turbine. Due in part to the importance of TI estimates to the wind energy industry, it is important that LIDAR instruments are able to accurately determine TI in order to be considered a viable alternative to in situ instruments and met towers.

Related art methods for improving LIDAR-based TI estimates may include the use of analytical turbulence models and expensive scanning LIDAR instruments. While these methods may provide sufficiently accurate results in a research setting, they cannot be easily applied to smaller, commercially available LIDAR instruments (e.g., vertically profiling LIDAR instruments) in locations where high-resolution sonic anemometer data are not available. There is a need for TI error reduction systems and devices that are simpler and more easily utilized with LIDAR instruments, such as those used in the wind energy industry.

In the present disclosure, TI error reduction systems and devices for use with LIDAR instruments are described. These systems and devices may use data from stand-alone, commercially available LIDAR instruments and may not require any extensive training for users with meteorological tower data. One basis of the techniques used by the systems and devices described herein is a series of corrections (e.g., spectral correction) that may be applied to LIDAR instrument measurements to mitigate errors from instrument noise, volume averaging, variance contamination, and other sources. These corrections may be applied in conjunction with the application of a mathematical or statistical model trained using machine learning to improve LIDAR-based TI estimates. In some examples, the improved or corrected TI estimates may be related to changes in power prediction using a power prediction model. Unlike related art methods for improving LIDAR-based TI estimates, the techniques described herein may be easily used with commercially available LIDAR instruments.

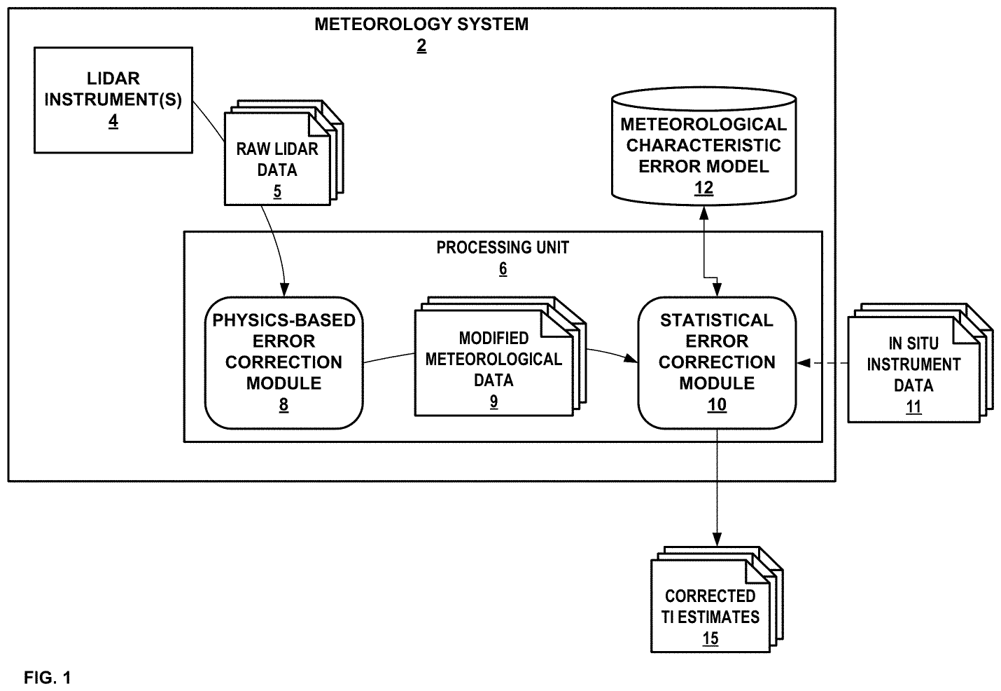

FIG. 1 is a block diagram illustrating one example of an error compensating meteorology system (e.g., meteorology system 2), in accordance with one or more aspects of the present disclosure. Meteorology system 2, as shown in FIG. 1, represents only one example of a system configured to perform the techniques described herein, and various other meteorology systems may be configured in accordance with the techniques of the present disclosure. For instance, error compensating meteorology systems may, in other examples, include more or fewer components than shown in the example of FIG. 1. Furthermore, while shown in the example of FIG. 1 as a combined system, meteorology system 2 may, in some examples, include one or more separate, interconnected components. In other words, meteorology system 2 may, in some examples, be a system of networked components that are not in the same geographical location.

In the example of FIG. 1, meteorology system 2 includes one or more LIDAR instruments (e.g., LIDAR instruments 4). LIDAR instruments 4 represent devices and/or systems that are configured to emit laser light into the atmosphere and measure the Doppler shift of the backscattered energy to estimate the mean wind velocity of volumes of air. Laser light from Doppler LIDAR instruments may typically be scattered by aerosol particles in the atmosphere. These aerosol particles are normally prevalent in the atmospheric boundary layer.

For pulsed Doppler LIDAR instruments, the time series of the returned signal may be split into blocks that correspond to range gates and processed to estimate the average radial wind speed at each range gate. The sign and magnitude of the radial wind speed may be determined from the Doppler shift of the returned signal with respect to the original signal.

As one specific, non-limiting example, LIDAR Instruments 4 may represent Version 2 of the WINDCUBE vertically profiling LIDAR (hereinafter “WINDCUBE” or “WC”), manufactured by LEOSPHERE of Orsay, France. The WC employs a Doppler-Beam Swinging (DBS) technique to estimate the three-dimensional wind vector wherein an optical switch is used to point the laser beam toward the four cardinal directions (north, east, south, and west) at an angle of twenty-eight degrees from zenith. The WC also includes a vertical beam position for a direct measurement of the vertical velocity. The WC accumulates measurements at each beam position for one second, such that a full scan takes approximately four to five seconds. However, velocity data from the WC are updated each time new information is obtained (i.e., every time the beam moves to a different position), leading to an output frequency of 1 Hz. While the WC represents one specific example of a LIDAR instrument with which the techniques of the present disclosure may be employed, the systems, devices, and techniques described herein may be used with any other suitable LIDAR instruments (e.g., LIDAR instruments employing different measurement techniques, scanning strategies, and/or output frequencies) with minimal modifications.

LIDAR instruments 4, in the example of FIG. 1, may output raw LIDAR data (e.g., raw LIDAR data 5). Raw LIDAR data 5 may be data representing the wind speed measurements or values taken by LIDAR instruments 4. For instance, raw LIDAR data 5 may be a time-ordered series of wind velocity measurements. For the WC system, for example, these measurements may include radial wind speeds from each LIDAR beam position in addition to wind speed components in the north-south, east-west, and vertical directions that have been calculated using a wind field reconstruction technique. For other vertically profiling LIDAR instruments, such as the ZephIR 300 model, these measurements may include estimates of the horizontal wind speed, vertical wind speed, and wind direction that have been calculated using a wind field reconstruction technique. Raw LIDAR data 5 may, in some examples, include other information, such as a time corresponding to each piece of data, an altitude or distance corresponding to the data, a signal-to-noise ratio indicating the relative concentration of aerosol particles at the measurement point, or other information.

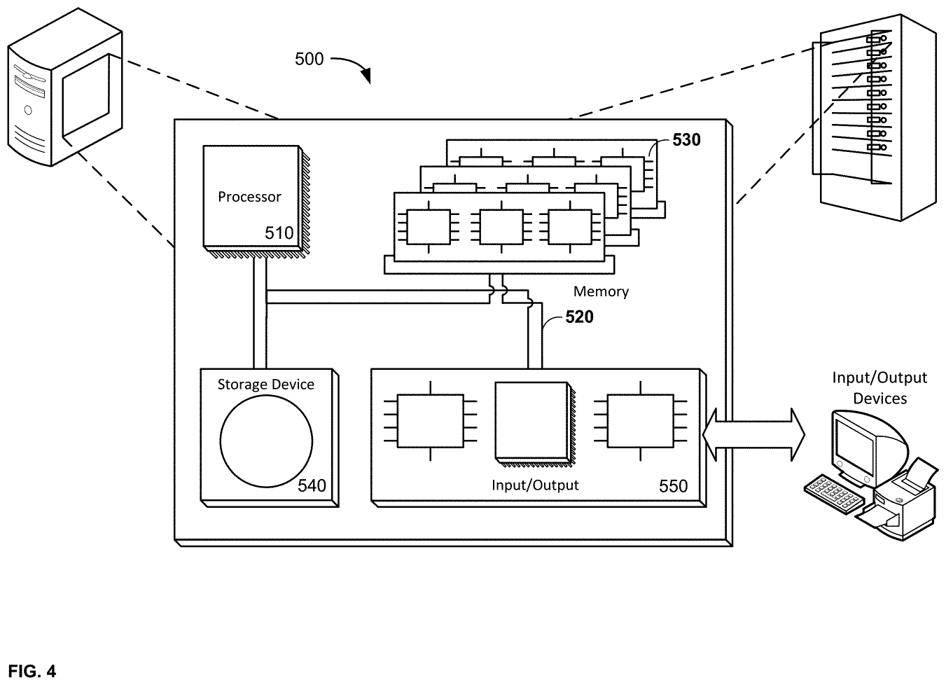

In the example of FIG. 1, meteorology system 2 includes a processing unit (e.g., processing unit 6). Processing unit 6 may represent a processor or other digital logic configured to execute the modules described herein. Processing unit 6 is further described with respect to FIG. 4, below. As shown in the example of FIG. 1, processing unit 6 includes physics-based error correction module 8 and statistical error correction module 10.

Physics-based error correction module 8 may be configured to receive raw LIDAR data 5. Raw LIDAR data 5 may represent actual measurements taken by LIDAR instruments 4. In some examples, physics-based error correction module 8 may additionally or alternatively be configured to receive LIDAR-based meteorological data (not shown). For example, a pre-processing module (not shown) may receive raw LIDAR data 5 and pre-process the data to derive one or more meteorological characteristic values from raw LIDAR data 5. That is, LIDAR-based meteorological data may represent one or more meteorological characteristic values determined based on raw LIDAR data 5. LIDAR-based meteorological data may include wind shear information, TI information, average wind speed and/or wind direction at different altitudes, or other relevant meteorological information that may be determined based on raw LIDAR data 5.

Physics-based error correction module 8 may receive raw LIDAR data 5 and/or the LIDAR-based meteorological data and perform one or more physics-based corrections to produce modified meteorological data 9. Physics-based corrections may incorporate techniques to reduce error from, for example, LIDAR instrument noise and volume averaging. These techniques may involve processing raw LIDAR data 5 and/or the LIDAR-based meteorological data to apply meteorological or physics theories to correct errors in TI estimates derived from raw LIDAR data 5.

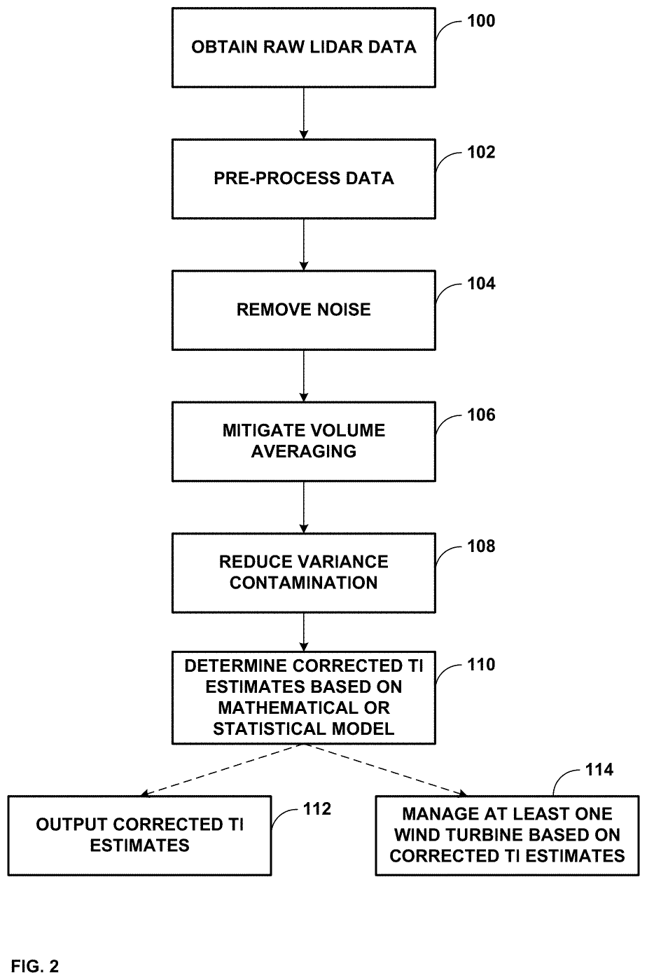

As the main sources that cause error in LIDAR-based TI estimates change depending on the current atmospheric conditions, these physics-based corrections may, in some examples, adapt to the atmospheric conditions associated with each LIDAR-based TI estimate and apply an appropriate set of corrections. Various physics-based corrections may be further described with respect to FIG. 2, below. Physics-based error correction module 8 may output modified meteorological data 9 to statistical error correction module 10.

Modified meteorological data 9 includes meteorological characteristic values that have been modified to better account for error due to physical aspects of the measurement methods (e.g., the way that LIDAR instruments 4 work) and/or meteorological factors. In some examples, meteorological data 9 may include one or more unmodified meteorological characteristic values. For instance,

Statistical error correction module 10 may be configured to receive modified meteorological data 9 and use a mathematical or statistical model (e.g., meteorological characteristic error model 12) to produce corrected TI estimates 15. That is, statistical error correction module 10 may further reduce error in TI estimates by applying a mathematical or statistical model to the TI estimates resulting from the physics-based corrections.

In some examples, statistical error correction module 10 may also be configured to receive in situ instrument data 11. The dashed line of FIG. 1 between statistical error correction module 10 and in situ instrument data 11 is used to show that in situ instrument data 11 may not always be received. That is, in some examples, statistical error correction module 10 may receive in situ instrument data 11 during a training phase, as described herein.

In situ instrument data 11 may represent one or more measurements of meteorological characteristics as determined by in-situ instruments of a met tower (e.g., a cup anemometer, a sonic anemometer, a weather vane, etc.). Using the techniques described herein, statistical error correction module 10 may generate meteorological characteristic error model 12 based on corrected meteorological data 9 and in situ instrument data 11. For instance, statistical error correction module 10 may apply machine learning techniques to generate meteorological characteristic error model 12. Given a set of raw LIDAR-based corrected meteorological data, meteorological characteristic error model 12 may be usable to make a prediction of what measurements a met tower (e.g., in situ instruments thereon) would make, were the met tower at the same area as the LIDAR instrument.

As a specific example of operation, meteorology system 2, as shown in the example of FIG. 1, may be deployed in approximately the same location as a met tower (not shown) during a training phase. Meteorology system 2 may obtain raw LIDAR data 5 using LIDAR instruments 4 and determine various LIDAR-based meteorological characteristics, such as TI, wind shear, wind speed profiles, and/or other characteristics. Instruments on the met tower may also be used to simultaneously measure and/or determine these meteorological characteristics. During a training phase, statistical error correction module 10 may receive corrected meteorological data 9, in situ instrument data 11, and/or other information. Based at least in part on the two sets of meteorological data, statistical error correction module 10 may generate and/or train meteorological characteristic error model 12. Thereafter, mathematical module 12 may be used to predict differences between the LIDAR-based and in situ instrument-based TI estimates. The inputs to meteorological characteristic error model 12 may, in various examples, include meteorological parameters, such as TI estimates, wind speed profiles, wind shear, or other meteorological parameters, as well as other information, such as information about LIDAR instruments 4 (e.g., scanning mode, instrument temperature, positioning, etc.), and/or any number of other variables. The output from meteorological characteristic error model 12 may be used to predict the difference between LIDAR-based and in situ instrument-based TI estimates.

In machine learning, a mathematical or statistical model is typically trained using a random subset of data and then tested on other, remaining data, ensuring that the model has not been overfit to the training dataset. In some examples, choices for the machine learning model may include variations of the random forest technique or other techniques. In some examples, a different instance of meteorological characteristic error model 12 may be created each time the training process is completed and/or a different subset of training data is selected. Statistical error correction module 10 may, in some examples, store an updated version of meteorological characteristic error model 12 at the end of each training process. That is, meteorology system 2 may, in various examples, undergo more than one training phase and/or may include more than one model. Ideally, the training phase will incorporate several months of met tower and LIDAR data collected at different sites and under different atmospheric conditions such that that the trained model is capable of making accurate predictions in a variety of different conditions. In some examples, meteorology system 2 may receive input from a user (e.g., a researcher, a wind farm manager, a data analyst, etc.) selecting a particular model or some combination of models developed using different training subsets.

After the model has been developed and selected, meteorology system 2 may be deployed at a site without a met tower during an operation phase. During the operation phase, meteorology system 2 may make measurements using LIDAR instruments 4 and apply the physics-based corrections and the trained version of meteorological characteristic error model 12 to the raw LIDAR data in order to correct the TI estimates so that they resemble the TI estimates that would likely be determined based on measurements made by a met tower at the same location. That is, LIDAR instruments 4 generate raw LIDAR data 5, and modules 8 and 10 apply corrections in order to generate corrected TI estimates 15.

In some examples, meteorology system 2 may run in real time, correcting raw LIDAR data 5 as it is generated by LIDAR instruments 4. In other examples, meteorology system 2 may operate as a post processing step. For instance, modules 8 and 10 may be fed a set of raw LIDAR data 5. This may happen a single time (e.g., as part of research), or happen periodically (e.g., every 10 minutes, every hour, every day, etc.).

While shown in the example of FIG. 1 as a unified system, meteorology system 2 may, in some examples, be separate. As one example, a user of a LIDAR device may record and store raw LIDAR data 5, and a supplier or the LIDAR device may use modules 8 and 10 to apply corrections to the recorded measurements periodically. In some examples, different LIDAR instruments may be associated with their own version of meteorological characteristic error model 12. For instance, models may be trained by a LIDAR manufacturer as part of production of each meteorology system. As another example, a LIDAR instrument user may train his or her meteorology system at a site with a met tower before deploying the meteorology system at a site without a met tower. In general, models can be adapted to any LIDAR instrument or LIDAR-based method for determining TI estimates.

FIG. 2 is a flow diagram illustrating example operations for correcting TI estimates, in accordance with one or more aspects of the present disclosure. FIG. 2 represents only one example process for correcting TI estimates, and various other operations may be used by the systems and devices described herein in other examples. The example operations of FIG. 2 are described below within the context of FIG. 1.

In the example of FIG. 2, a meteorology system (e.g., meteorology system 2) may obtain raw LIDAR data (100). For example, meteorology system 2 may receive the raw LIDAR data from LIDAR instruments 4. In some examples, meteorology system 2 may obtain raw LIDAR data in real time or near-real time, while in other examples, meteorology system 2 may receive raw LIDAR data that was previously stored.

In some examples, meteorology system 2 may pre-process the raw LIDAR data (102). As one example of pre-processing, when the raw LIDAR data is a radial velocity time series, meteorology system 2 may determine wind speed component values, u, v, and w, based on the raw LIDAR data. Component values may be determined periodically at various frequencies, depending on the specific LIDAR instrument used. For instance, when using the WC, meteorology system 2 may determine new component values every time the LIDAR beam moves to a new position (e.g., every second) or by determining new component values after every full scan (e.g., every four seconds), similar to a Velocity-Azimuth Display (VAD) technique.

As part of pre-processing, meteorology system 2 may, in some examples, interpolate the component values to a grid with constant temporal spacing. This may be helpful for determining statistical measures, such as variance and spectra, because the frequency resolution of the measurements will be constant. Meteorology system 2 may also determine the mean horizontal wind speed and shear parameter during pre-processing, as these parameters may be largely unaffected by the errors that plague LIDAR-based TI estimates.

Meteorology system 2 may determine the 10-minute mean horizontal wind speed, Ū, as follows:

Ū=(̅u̅²̅+̅v̅²̅)̅^̅{̅1̅/̅2̅}̅, (1)

where u and v are the east-west and north-south wind components, respectively, and the overbar denotes temporal averaging. Meteorology system 2 may determine the shear parameter, α, from the standard power law equation:

$$U ( z ) = U ( {z}_{r} ) {( \frac{z}{{z}_{r}} )}^{α} , \qquad ( 2 )$$

where z is height above ground and zᵣ is a reference height. Equation 2 may be simplified by setting U(zᵣ)zᵣ^{-α} equal to a constant, β. The power law then becomes the following:

U(z)=βz^{α}. (3)

A 10-minute mean value of a can be found by taking the natural logarithm of Equation 3 and fitting the resulting equation to a straight line. As one specific example, values of Ū measured by the WC between 40 and 200 meters may be used to calculate values of α.

Meteorology system 2 may rotate the raw wind speeds into a new coordinate system by forcing v̅ and w̅ to zero and aligning u with the 10-minute mean wind direction. The TI is then defined by the following equation:

$$TI = ( \frac{{σ}_{u}}{\overline{u}} ) \times 100 \% , \qquad ( 4 )$$

where σᵤ is the standard deviation of u over a 10-minute period, defined in the new coordinate system, and ū is the 10-minute mean wind speed. Equation 4 gives the initial LIDAR-estimated value of the horizontal TI. Similar pre-processing may be used to determine TI estimates using in situ instrument (e.g., cup and sonic anemometer) data. Pre-processing may result in an interpolated time series of U, α, and TI values.

In the example of FIG. 2, meteorology system 2 may remove noise from the pre-processed data (104). That is, in some examples, the interpolated time series resulting from pre-processing may be noisy due to various aberrations. The time series may include a number of outlying values that are not accurate representations and these outliers may reduce the accuracy of LIDAR-based TI estimation. Thus, such outliers may be removed.

As one specific example of noise removal, physics-based error correction module 8 may apply one or more noise removal methods, such as a spike filter, to the pre-processed data. In various examples, physics-based error correction module 8 may use various known methods of removing noise. Some such methods may use a velocity spectrum and/or autocovariance function of LIDAR instruments 4 to determine the amount of noise in the variance measurements from LIDAR instruments 4.

In the example of FIG. 2, meteorology system 2 may mitigate the effects of volume averaging (106). For example, physics-based error correction module 8 may utilize structure functions and/or spectral extrapolation to mitigate the potential error resulting from volume averaging by LIDAR instruments 4.

Structure functions may describe the spatial correlation of a variable at different separation distances. If the turbulence is isotropic and the turbulence length scale is large, the structure function can be approximated by the Kolmogorov model and used to estimate the velocity variance. The literature includes a number of examples of using scanning LIDAR instrument data from a field campaign to calculate structure functions in both the along-beam and azimuthal directions and fit the functions to the Kolmogorov model to obtain estimates of the velocity variance. In some examples, the LIDAR data used to generate a structure function may be obtained from a series of plan-position indicator (PPI) scans with high azimuthal resolution, which may not available from a scanning strategy used by a commercially available LIDAR instrument. While estimation of structure functions with a LIDAR may be more useful with a high-resolution PPI scan, structure functions may also be estimated from DBS scans. That is, suitable structure functions can be estimated using available LIDAR data and fit to modeled forms of structure functions to estimate turbulence parameters. By fitting the LIDAR data to a model, the reduction of TI estimates due to volume averaging may be mitigated.

Spectral extrapolation refers to modeling the LIDAR velocity spectrum and using the model to extrapolate the spectrum to higher frequencies. The high-frequency part of the modeled spectrum may then be integrated to obtain an estimate of the variance that is not measured by the LIDAR instrument as a result of spatial and/or temporal resolution.

In the example of FIG. 2, meteorology system 2 may reduce variance contamination (108). For instance, physics-based error correction module 8 may utilize the six-beam technique and/or Taylor's frozen turbulence hypothesis to estimate the change in the vertical velocity across the LIDAR scanning circle.

The six-beam technique may reduce variance contamination caused by the DBS and VAD scans by using a six-beam scanning technique for Doppler LIDAR instruments. While DBS and VAD involve using radial velocities to estimate the u, v, and w wind components and calculating the variance, the six-beam technique uses the variances of the radial velocities measured at six different beam positions to estimate the variance and covariance components.

Taylor's frozen turbulence hypothesis relies on the assumption that advection contributed by turbulent circulations themselves is small and that therefore the advection of a field of turbulence past a fixed point can be taken to be entirely due to the mean flow. Based on this assumption, temporal changes in velocity data collected at a single point can be related to spatial changes in the velocity field. For example, LIDAR instruments 4 may employ a vertical beam position where the vertical component of the velocity is directly measured at the same point once per scan. Using Taylor's frozen turbulence hypothesis and the mean horizontal wind speed, an estimate can be made of the time it takes for a turbulent eddy to move from the center of the scanning circle (i.e., the position where the vertically pointing beam is collecting data) to the edge of the scanning circle. The vertical velocity time series collected by the vertical beam can then be time-shifted to approximate the vertical velocity measured at opposite ends of the scanning circle. These vertical velocity estimates can be used to reduce the impact of vertical velocity on variance contamination.

Operations 104, 106, and 108, as described with respect to FIG. 2, may represent physics-based corrections that rely only on data from the LIDAR instrument itself, and use theory, rather than mathematical or statistical models. In other words, physics-based error correction module 8 may utilize information about LIDAR instruments 4 to determine potential inaccuracies in the obtained LIDAR data and modify the data underlying TI values using real-world relationships in order to reduce error. While these physics-based corrections will reduce LIDAR-based TI estimation errors, LIDAR-based TI estimation may still not always track TI estimation based on in situ instrument measurements.

In the example of FIG. 2, meteorology system 2 may determine corrected TI estimates based on a meteorological characteristic error model (110). For instance, statistical error correction module 10 may utilize various machine-learning methods to create a meteorological characteristic error model that compares LIDAR instrument data and in situ (e.g., met tower) instrument data to determine a predicted difference between the two. Statistical error correction module 10 may modify estimates of TI (e.g., determined using the corrected LIDAR data) based on the predicted difference in order to determine corrected TI estimates. Examples of suitable machine-learning methods include the random forest method, the support vector regression method, and/or the multivariate adaptive regression splines (MARS) method. Various other machine-learning methods may alternatively or additionally be used, however, in accordance with the techniques described herein.

The random forest method may include constructing a series of decision trees (e.g., at the time of training) with different subsets of the data. The decision trees may be averaged to form a random forest to make predictions. Random forests are capable of separating data into different categories through decisions made at each node. For example, the path taken through the random forest, and the resulting prediction of TI estimates, depend on the values of the input parameters. This categorical separation makes random forests well-suited for physical problems such as TI correction, as the random forest is capable of using the input parameters to group atmospheric conditions into different categories and making predictions based on these categories.

The support vector regression method may utilize a support vector machine model that depends only on a subset of the training data, because the cost function for building the model ignores any training data close to the model prediction. The MARS method is an extension of linear models that automatically models nonlinearities and interactions between variables. In the MARS method, nonlinearities are modeled through the use of hinge functions, functions of the form max(a, b) where the value of the function is a if a>b and b otherwise. This allows the behavior of the model to change depending on the location within the dataset. The output variable is then determined through linear combinations of these hinge functions. Interactions between variables can be modeled by taking the product of two hinge functions that incorporate different variables.

Potential predictor variables for machine-learning models may be divided into two broad categories: atmospheric state and LIDAR operating characteristics. Atmospheric state variables may include, for example, shear parameter, mean wind speed, Doppler spectral broadening, and u and w velocity variances. LIDAR operating characteristics may include, for example, signal-to-noise ratio (SNR) and internal instrument temperature. Mean wind speed may also affect data quality, as LIDAR instruments may not be able to measure turbulence at low wind speeds as accurately as a result of relative intensity noise. Any number and combination of predictor variables may be used in various examples. What variables are used may depend on the LIDAR instrument used, the physical environment(s) in which the meteorology system is deployed, and other factors. As one specific example combination of variables, statistical error correction module 10 may generate and use a model based on TI from the physics-based corrections, α, SNR, σ_{w}² (e.g., w velocity variance), spectral broadening, LIDAR instrument internal temperature, and pitch of the LIDAR instrument.

In some examples, meteorology system 2 may output the corrected TI estimates (112). For example, meteorology system 2 may include one or more user interface (UI) devices capable of providing output to a user of meteorology system 2. In this way, meteorology system 2 may provide the corrected TI values to a wind plant manager, a wind turbine technician, or other user for use in managing wind turbines and/or wind farms.

In some examples, meteorology system 2 may additionally or alternatively manage at least one wind turbine based on the corrected TI estimates (114). For example, meteorology system 2 may include a wind turbine configuration module (not shown) that receives the corrected TI estimates and modifies at least one operating parameter of a wind turbine based on the corrected TI estimates. In various examples, the wind turbine configuration module may, based on the corrected TI estimates, change the blade pitch angle of the turbine to maximize power output and minimize loads on the turbine, shut down the turbine to avoid damaging effects of high turbulence, or turn on additional turbines to compensate for a loss in power due to turbulence.

Additionally, reduction in TI estimate error may be related to reduction in wind turbine power prediction error through the use of a power prediction model. As another example of managing at least one wind turbine based on the corrected TI estimates, meteorology system 2 may utilize the corrected TI estimates to determine a predicted power, and manage the at least one wind turbine to maximize the predicted power.

As one example of a power prediction model, the 10-minute mean hub-height wind speed, the hub-height TI, and the shear parameter, as well as the 10-minute mean turbine power may be extracted from a turbine simulation output. These parameters, in addition to the turbine operating range, may then be used to train a mathematical or statistical model using, for example, the random forest method described above. Such a model may utilize values of mean wind speed, TI, and shear as inputs to predict the 10 min mean power that would be produced by the simulated wind turbine.

In some examples, meteorology system 2 may be used in a wind resource assessment campaign, where measurements of wind speed, shear, and TI are collected at a potential wind farm site to assess the suitability of the site for building wind turbines. Wind energy developers could use corrected TI estimates 15 to assist in selecting the appropriate turbines to build at the site, as well as an optimal layout for the wind plant. Meteorology system may additionally or alternatively be used at an operational wind farm for power performance testing, where meteorological measurements are collected upwind of a test turbine and related to power produced by the turbine to compare the actual performance of the turbine in conditions experienced at the wind farm to the performance guaranteed by the turbine manufacturer. Results from the power performance test can then be used for finance purposes or other purposes.

By performing the example operations of FIG. 2, meteorology systems and devices may determine more accurate measurements of TI, thereby allowing for improved management and utilization of wind plan resources. In various examples, systems and/or devices may not perform all of the operations of FIG. 2, or may perform additional operations not shown in FIG. 2. For instance, meteorology system 2 may additionally or alternatively utilize other known physics-based error correction techniques and/or other known mathematical or statistical modeling techniques to reduce TI estimate error within the scope of this disclosure.

The techniques described herein may additionally or alternatively be described by the following non-limiting examples.

### EXAMPLE 1

A system includes: a LIDAR instrument configured to: emit light, receive reflections of the light, and determine, based on the reflections, a plurality of wind speed values; a physics-based error correction module configured to: determine, based on the plurality of wind speed values, at least one LIDAR-based meteorological characteristic value, and determine, based on the at least one LIDAR-based meteorological characteristic value and at least one physical characteristic of the LIDAR instrument, at least one modified meteorological characteristic value; and a statistical error correction module configured to: determine, based on the at least one modified meteorological characteristic value and a meteorological characteristic error model generated using collocated LIDAR-based meteorological characteristic values and in situ instrument-based meteorological characteristic values, at least one corrected turbulence intensity estimate, and output the at least one corrected turbulence intensity estimate.

### EXAMPLE 2

The system of example 1, further including a wind turbine configuration module configured to: receive the at least one corrected turbulence intensity estimate; and modify, based on the at least one corrected turbulence intensity estimate, at least one operating parameter of a wind turbine.

### EXAMPLE 3

The system of example 2, wherein the wind turbine configuration module is configured to modify the at least one operating parameter by: modifying a blade pitch angle of the wind turbine to achieve an output power value.

### EXAMPLE 4

The system of any of examples 2-3, wherein the wind turbine configuration module is configured to modify the at least one operating parameter by: responsive to determining that the at least one corrected turbulence intensity estimate exceeds a threshold value, engaging a rotor lock of the wind turbine.

### EXAMPLE 5

The system of any of examples 1-4, wherein the physics-based error correction module is configured to determine the at least one modified meteorological characteristic value based on at least one of a velocity spectrum associated with the LIDAR instrument, an autocovariance function associated with the LIDAR instrument.

### EXAMPLE 6

The system of any of examples 1-5, wherein the physics-based error correction module is configured to determine the at least one modified meteorological characteristic value by performing at least one of: applying, to the at least one LIDAR-based meteorological characteristic value, a spike filter that removes noise resulting from the LIDAR instrument; applying, to the at least one LIDAR-based meteorological characteristic value, at least one of a structure function or a spectral extrapolation model that reduces turbulence intensity error due to volume averaging by the LIDAR instrument; or applying, to the at least one LIDAR-based meteorological characteristic value, a six-beam technique to reduce variance contamination experienced by the LIDAR instrument.

### EXAMPLE 7

The system of any of examples 1-6, wherein the at least one modified meteorological characteristic value includes a modified turbulence intensity value.

### EXAMPLE 8

The system of any of examples 1-7, wherein the statistical error correction module is further configured to generate the meteorological characteristic error model using machine learning.

### EXAMPLE 9

The system of any of examples 1-8, wherein the statistical error correction module is configured to generate the meteorological characteristic error model using at least one of: a random forest method, a support vector regression method, or a multivariate adaptive regression splines method.

### EXAMPLE 10

The system of any of examples 1-9, wherein the physics-based error correction module is configured to determine the at least one modified meteorological characteristic value based on at least one atmospheric condition.

### EXAMPLE 11

A method including: receiving, by a computing device and from a LIDAR instrument operatively coupled to the computing device, a plurality of wind speed values; determining, by the computing device and based on the plurality of wind speed values, at least one LIDAR-based meteorological characteristic value; determining, by the computing device and based on the at least one LIDAR-based meteorological characteristic value and at least one physical characteristic of the LIDAR instrument, at least one modified meteorological characteristic value; determining, by the computing device and based on the at least one modified meteorological characteristic value and a meteorological characteristic error model generated using collocated LIDAR-based meteorological characteristic values and in situ instrument-based meteorological characteristic values, at least one corrected turbulence intensity estimate; and outputting, by the computing device, instructions to cause modification of at least one operating parameter of a wind turbine based on the at least one corrected turbulence intensity estimate.

### EXAMPLE 12

The method of example 11, wherein the instructions to cause modification of at least one operating parameter of a wind turbine include instructions to modify a blade pitch angle of the wind turbine to achieve an output power value.

### EXAMPLE 13

The method of any of examples 11-12, wherein the instructions to cause modification of at least one operating parameter of a wind turbine include instructions to engage a rotor lock of the wind turbine responsive to determining that the at least one corrected turbulence intensity estimate exceeds a threshold value.

### EXAMPLE 14

The method of any of examples 11-13, wherein the at least one modified meteorological characteristic value is determined based on at least one of a velocity spectrum associated with the LIDAR instrument or an autocovariance function associated with the LIDAR instrument.

### EXAMPLE 15

The method of any of examples 11-14, wherein determining the at least one modified meteorological characteristic includes at least one of: applying, to the at least one LIDAR-based meteorological characteristic value, a spike filter that removes noise resulting from the LIDAR instrument; applying, to the at least one LIDAR-based meteorological characteristic value, at least one of a structure function or a spectral extrapolation model that reduces turbulence intensity error due to volume averaging by the LIDAR instrument; or applying, to the at least one LIDAR-based meteorological characteristic value, a six-beam technique to reduce variance contamination experienced by the LIDAR instrument.

### EXAMPLE 16

The method of any of examples 11-15, wherein the at least one modified meteorological characteristic value includes a modified turbulence intensity value.

### EXAMPLE 17

The method of any of examples 11-16, further including generating, using machine learning, the meteorological characteristic error model.

### EXAMPLE 18

The method of example 17, wherein generating the meteorological characteristic error model includes applying at least one of: a random forest method, a support vector regression method, or a multivariate adaptive regression splines method to the collocated LIDAR-based meteorological characteristic values and in situ instrument-based meteorological characteristic values.

### EXAMPLE 19

The method of any of examples 11-18, wherein determining the at least one modified meteorological characteristic value is further based on at least one atmospheric condition.

### EXAMPLE 20

A non-transitory computer-readable medium is encoded with instructions that, when executed, cause at least one processor to: receive, from a LIDAR instrument operatively coupled to the at least one processor, a plurality of wind speed values; determine, based on the plurality of wind speed values, at least one LIDAR-based meteorological characteristic value; determine, based on the at least one LIDAR-based meteorological characteristic value and at least one physical characteristic of the LIDAR instrument, at least one modified meteorological characteristic value; determine, based on the at least one corrected meteorological characteristic value and a meteorological characteristic error model generated using collocated LIDAR-based meteorological characteristic values and in situ instrument-based meteorological characteristic values, at least one corrected turbulence intensity estimate; and output instructions to cause modification of at least one operating parameter of a wind turbine based on the at least one corrected turbulence intensity estimate.

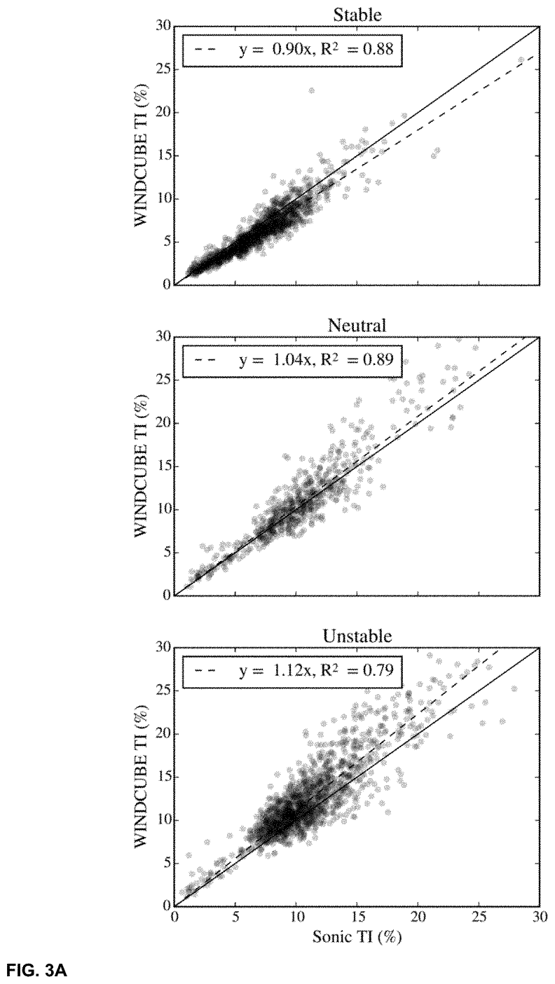

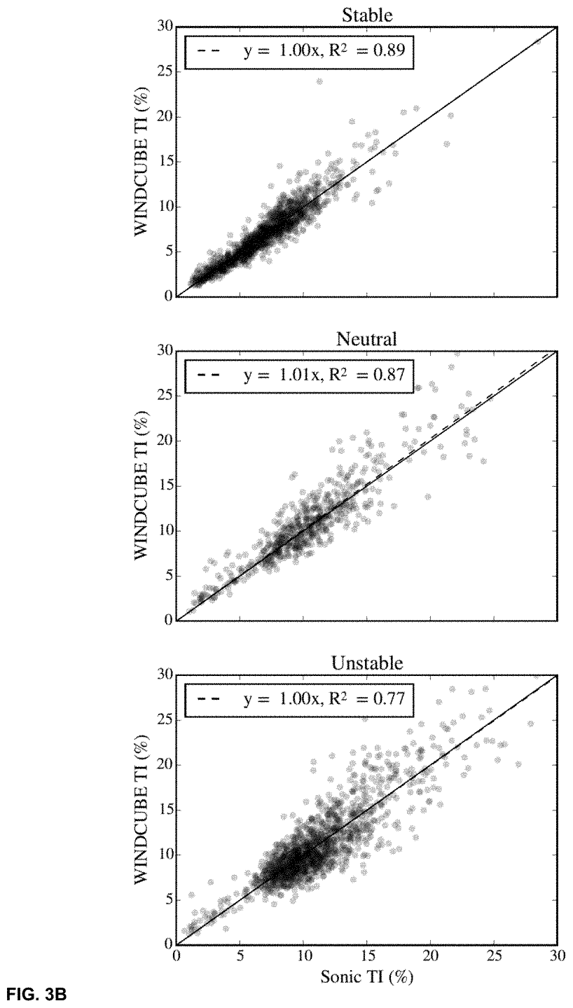

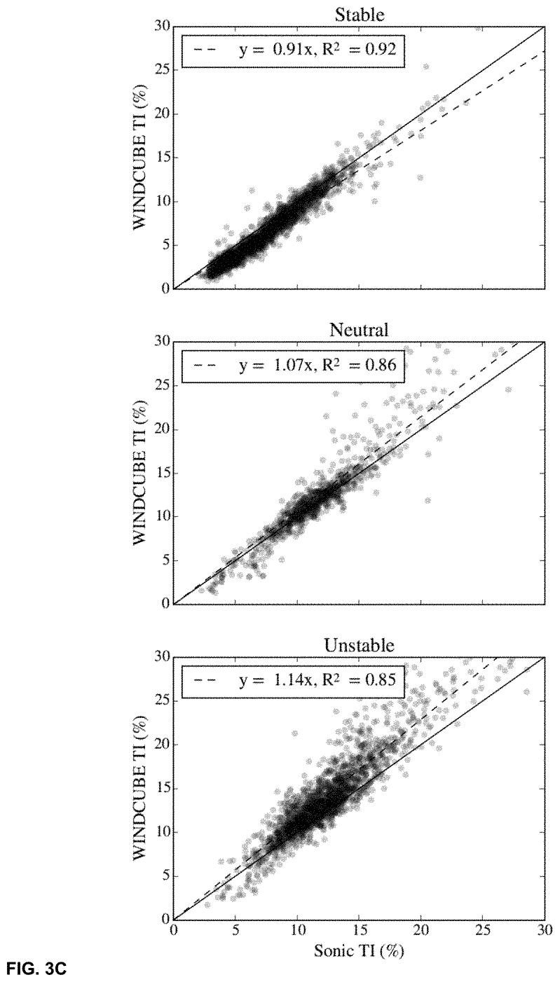

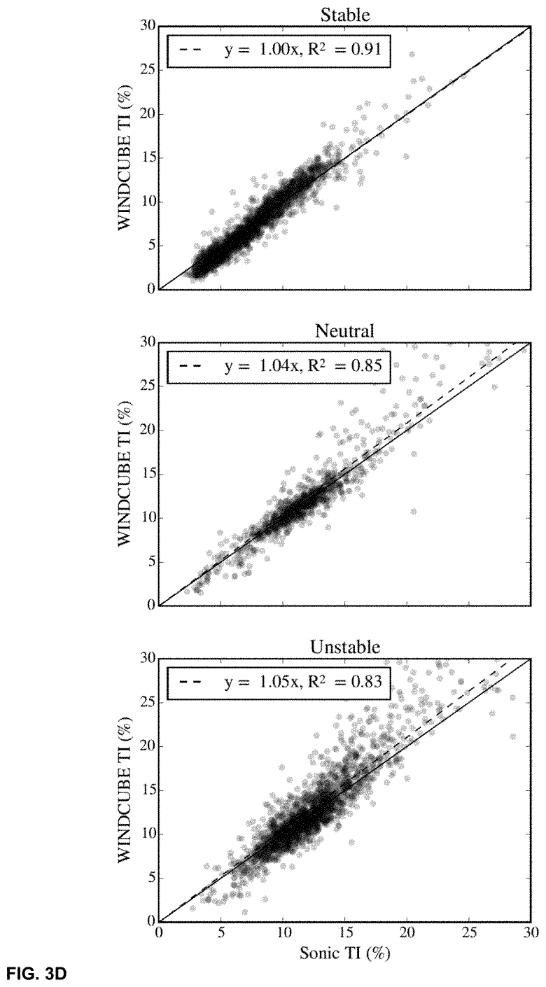

FIGS. 3A-3D are scatter plots illustrating example LIDAR-based TI estimates compared to in situ instrument-based TI estimates, in accordance with one or more aspects of the present disclosure. Specifically, FIGS. 3A and 3C illustrate the relationship between LIDAR-based TI estimates and TI estimates based on measurements from an in situ sonic anemometer at a first test site and at a second test site, respectively. FIGS. 3B and 3D illustrate the same relationships as in FIGS. 3A and 3C, respectively, but using corrected LIDAR-based TI estimates, determined using the techniques described herein. The improvement in LIDAR-based TI estimates after using the techniques described herein is clearly evident when comparing FIGS. 3A and 3C to FIGS. 3B and 3D, respectively.

By employing both physics-based error correction and machine-learning-based error correction, the techniques described herein may provide substantially improved TI estimates when employing LIDAR instruments. These improved TI estimates may, in turn, improve power estimates for wind farms. More accurate TI estimates and/or more accurate power estimates may be used to improve wind turbine and/or wind farm performance in various ways, as described herein.

FIG. 4 is a block diagram showing a detailed example of various devices that may be configured to implement some embodiments in accordance with one or more aspects of the present disclosure. For example, device 500 may be part of a meteorology system (e.g., error compensating meteorology system 2 of FIG. 1), a wind farm controller, a workstation, a computing center, a cluster of servers or other example embodiments of a computing environment, centrally located or distributed, capable of executing the techniques described herein. Any or all of the devices may, for example, implement portions of the techniques described herein for LIDAR-based TI estimate error reduction.

In the example of FIG. 4, device 500 includes processor 510 that is operable to execute program instructions or software, causing device 500 to perform various methods or tasks, such as performing the techniques for reducing error in LIDAR-based TI estimates as described herein. Processor 510 is coupled via bus 520 to memory 530, which may be used to store information such as program instructions and other data while device 500 is in operation. Storage device 540, such as a hard disk drive, nonvolatile memory, or other non-transient storage device stores information such as program instructions, LIDAR-based LIDAR measurements, in situ (e.g., met tower) instrument measurements, trained mathematical or statistical models, and other information. Device 500 also includes various input-output elements 550, including parallel or serial ports, USB, Firewire or IEEE 1394, Ethernet, and other such ports to connect device 500 to external devices such a LIDAR instrument, a wind farm controller, in situ instruments, a keyboard, a monitor, or the like. Other input-output elements include wireless communication interfaces such as Bluetooth, Wi-Fi, and cellular data networks.

Device 500, in various examples, may be a traditional personal computer, a rack-mount or business computer or server, or any other type of computerized system. Device 500 may include fewer than all elements listed above, such as a thin client or mobile device having only some of the shown elements. In another example, device 500 may be distributed among multiple computer systems, such as a distributed server that has many computers working together to provide various functions.

In one or more examples, the functions described may be implemented in hardware, software, firmware, or any combination thereof If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media, which includes any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable storage medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of inter-operative hardware units, including one or more processors as described above, in conjunction with suitable software and/or firmware.

The foregoing disclosure includes various examples set forth merely as illustration. The disclosed examples are not intended to be limiting. Modifications incorporating the spirit and substance of the described examples may occur to persons skilled in the art. These and other examples are within the scope of this disclosure.

What is claimed is:

1. A system comprising:
a LIDAR instrument configured to:
emit light,
receive reflections of the light, and
determine, based on the reflections, a plurality of wind speed values;
a physics-based error correction module configured to:
determine, based on the plurality of wind speed values, at least one LIDAR-based meteorological characteristic value, and
determine, based on the at least one LIDAR-based meteorological characteristic value and at least one physical characteristic of the LIDAR instrument, at least one modified meteorological characteristic value; and
a statistical error correction module configured to:
determine, based on the at least one modified meteorological characteristic value and a meteorological characteristic error model generated using collocated LIDAR-based meteorological characteristic values and in situ instrument-based meteorological characteristic values, at least one corrected turbulence intensity estimate, and
output the at least one corrected turbulence intensity estimate.

2. The system of claim 1, further comprising a wind turbine configuration module configured to:
receive the at least one corrected turbulence intensity estimate; and
modify, based on the at least one corrected turbulence intensity estimate, at least one operating parameter of a wind turbine.

3. The system of claim 2, wherein the wind turbine configuration module is configured to modify the at least one operating parameter by:
modifying a blade pitch angle of the wind turbine to achieve an output power value.

4. The system of claim 2, wherein the wind turbine configuration module is configured to modify the at least one operating parameter by:
responsive to determining that the at least one corrected turbulence intensity estimate exceeds a threshold value, engaging a rotor lock of the wind turbine.

5. The system of claim 1, wherein the physics-based error correction module is configured to determine the at least one modified meteorological characteristic value based on at least one of a velocity spectrum associated with the LIDAR instrument, an autocovariance function associated with the LIDAR instrument.

6. The system of claim 1, wherein the physics-based error correction module is configured to determine the at least one modified meteorological characteristic value by performing at least one of:
applying, to the at least one LIDAR-based meteorological characteristic value, a spike filter that removes noise resulting from the LIDAR instrument;
applying, to the at least one LIDAR-based meteorological characteristic value, at least one of a structure function or a spectral extrapolation model that reduces turbulence intensity error due to volume averaging by the LIDAR instrument; or
applying, to the at least one LIDAR-based meteorological characteristic value, a six-beam technique to reduce variance contamination experienced by the LIDAR instrument.

7. The system of claim 1, wherein the at least one modified meteorological characteristic value comprises a modified turbulence intensity value.

8. The system of claim 1, wherein the statistical error correction module is further configured to generate the meteorological characteristic error model using machine learning.

9. The system of claim 8, wherein the statistical error correction module is configured to generate the meteorological characteristic error model using at least one of: a random forest method, a support vector regression method, or a multivariate adaptive regression splines method.

10. The system of claim 1, wherein the physics-based error correction module is configured to determine the at least one modified meteorological characteristic value based on at least one atmospheric condition.

11. A method comprising:
receiving, by a computing device and from a LIDAR instrument operatively coupled to the computing device, a plurality of wind speed values;
determining, by the computing device and based on the plurality of wind speed values, at least one LIDAR-based meteorological characteristic value;
determining, by the computing device and based on the at least one LIDAR-based meteorological characteristic value and at least one physical characteristic of the LIDAR instrument, at least one modified meteorological characteristic value;
determining, by the computing device and based on the at least one modified meteorological characteristic value and a meteorological characteristic error model generated using collocated LIDAR-based meteorological characteristic values and in situ instrument-based meteorological characteristic values, at least one corrected turbulence intensity estimate; and
outputting, by the computing device, instructions to cause modification of at least one operating parameter of a wind turbine based on the at least one corrected turbulence intensity estimate.

12. The method of claim 11, wherein the instructions to cause modification of at least one operating parameter of a wind turbine comprise instructions to modify a blade pitch angle of the wind turbine to achieve an output power value.

13. The method of claim 11, wherein the instructions to cause modification of at least one operating parameter of a wind turbine comprise instructions to engage a rotor lock of the wind turbine responsive to determining that the at least one corrected turbulence intensity estimate exceeds a threshold value.

14. The method of claim 11, wherein the at least one modified meteorological characteristic value is determined based on at least one of a velocity spectrum associated with the LIDAR instrument or an autocovariance function associated with the LIDAR instrument.

15. The method of claim 11, wherein determining the at least one modified meteorological characteristic comprises at least one of:
applying, to the at least one LIDAR-based meteorological characteristic value, a spike filter that removes noise resulting from the LIDAR instrument;
applying, to the at least one LIDAR-based meteorological characteristic value, at least one of a structure function or a spectral extrapolation model that reduces turbulence intensity error due to volume averaging by the LIDAR instrument; or
applying, to the at least one LIDAR-based meteorological characteristic value, a six-beam technique to reduce variance contamination experienced by the LIDAR instrument.

16. The method of claim 11, wherein the at least one modified meteorological characteristic value comprises a modified turbulence intensity value.

17. The method of claim 11, further comprising generating, using machine learning, the meteorological characteristic error model.

18. The method of claim 17, wherein generating the meteorological characteristic error model comprises applying at least one of: a random forest method, a support vector regression method, or a multivariate adaptive regression splines method to the collocated LIDAR-based meteorological characteristic values and in situ instrument-based meteorological characteristic values.

19. The method of claim 11, wherein determining the at least one modified meteorological characteristic value is further based on at least one atmospheric condition.

20. A non-transitory computer-readable medium encoded with instructions that, when executed, cause at least one processor to:
receive, from a LIDAR instrument operatively coupled to the at least one processor, a plurality of wind speed values;
determine, based on the plurality of wind speed values, at least one LIDAR-based meteorological characteristic value;
determine, based on the at least one LIDAR-based meteorological characteristic value and at least one physical characteristic of the LIDAR instrument, at least one modified meteorological characteristic value;
determine, based on the at least one corrected meteorological characteristic value and a meteorological characteristic error model generated using collocated LIDAR-based meteorological characteristic values and in situ instrument-based meteorological characteristic values, at least one corrected turbulence intensity estimate; and
output instructions to cause modification of at least one operating parameter of a wind turbine based on the at least one corrected turbulence intensity estimate.
